(19) United States
(12) Patent Application Publication
(10) Pub. No.: US 2006/0120107 A1
(43) Pub. Date: Jun. 8, 2006

(54) LED backlight module

(76) Inventors: Yu-Nan Pao, Chupei City (TW); Po-Hung Yao, Hsinchu City (TW); Ming-Cheng Dai, Hsinchu City (TW); Mao-Hong Lu, Hsinchu City (TW)

Correspondence Address: PRO-TECTOR INTERNATIONAL SERVICES, 20775 NORADA CT., SARATOGA, CA, 95070, US

(21) Appl. No.: 11/058,451

(22) Filed: Feb. 14, 2005

(30) Foreign Application Priority Data
Dec. 8, 2004 (TW) 093137889

(51) Int. Cl. F21V 7/04

(52) U.S. Cl. 362/612

(57) ABSTRACT

An LED backlight module comprises a light box, at least one heat conductor, placed in said light box, a plurality of light emitting diodes (LEDs), mounted on said heat conductor, a plurality of light masks, covering said plurality of light emitting diodes, and a optical cover plate, set on said light box at upper side, thereof, diffusing light that passes through it.

### BACKGROUND OF THE INVENTION

1. Field of the Invention

The present invention relates to a backlight module for a display, particularly to an backlight module using light emitting diodes (LEDs) as light sources.

2. Description of Related Art

Currently, in liquid crystal displays (LCD) backlight module cold cathode fluorescent lamps (CCFLs) are used for lighting display screens. CCFLs, however, have the disadvantages of mercury pollution, high power consumption 15 and a short lifetime. In contrast thereto, LEDs have longer lifetime and do not cause environmental pollution. However, LEDs are point light sources which are hard to integrate into two-dimensional, planar light source. Furthermore, LEDs generate heat which adversely affects emitted light intensity and leads to shortened lifetime.

U.S. Pat. No. 6,607,286 “Lens and lens cap with sawtooth portion for light emitting diode” and U.S. Pat. No. 6,679,621 “Side emitting LED and lens” disclose an array of side-emitting LEDs as a light source. Of these, U.S. Pat. No. 6,607,286 teaches a light path which, by reflection and total reflection, varies between angles of 80 and 120 degrees. Light generated by an array of LEDs passes through an acryl plate with holes of various shapes into a light case, so that causes the diffusion of light.

This structure, however, is complicated, and generated heat is not dissipated effectively. An LED light source for a display therefore needs to be improved to accommodate the problem of insufficient dissipation of heat.

### SUMMARY OF THE INVENTION

It is an object of the present invention to provide an LED backlight module having a light mask to generate side-emission of light and to make light diffused in a light box.

Another object of the present invention is to provide an LED backlight module with improving dissipation of heat and reducing loss of light intensity due to intransparent material.

The LED backlight module of the present invention comprises a light box with four lateral walls and a base; a heat conductor on the base of the light box; an LED array, mounted on the heat conductor; a light mask, set above the LED array with a suitable distance and diffusing light generated thereby; and an optical cover plate placed on the light box, further diffusing light therefrom.

The present invention can be more fully understood by reference to the following description and accompanying drawings.

### BRIEF DESCRIPTION OF THE DRAWINGS

FIG. 1A is a front view of the LED backlight module of the present invention.

FIG. 1B is a side view of the LED backlight module of the present invention.

FIG. 1C is a perspective view of the LED backlight module of the present invention.

FIGS. 2A-2F are side views of the light mask of the present invention in various embodiments.

FIG. 3 is a side view of the light mask of the present invention in a further embodiment, having surfaces with microstructures of prisms.

FIG. 4 is a side view of the light mask of the present invention in a further embodiment, having diffractive surfaces made of material with varying refractive index.

### DETAILED DESCRIPTION OF THE PREFERRED EMBODIMENTS

As well known, a light spot becomes wider with increasing distance from the light source thereof, while a heat dissipating plate is most effective if it contacts to the light source directly. Therefore, the present invention employs a light source LEDs with an chip-on-board structure for improved heat dissipation and reducing intensity loss due to intransparent material. Light is diffused in the light box and by the light mask.

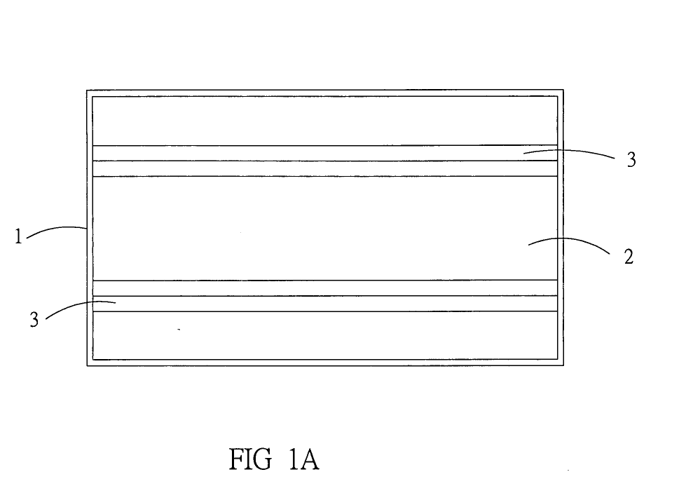

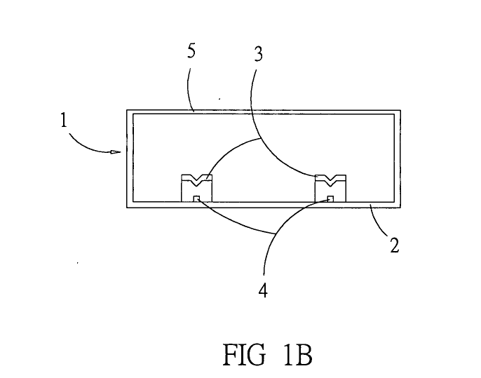

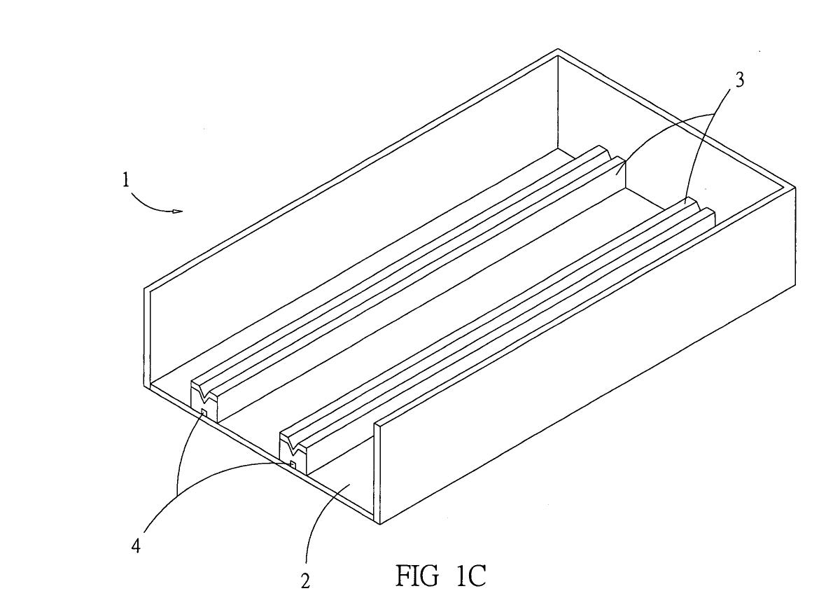

As shown in FIG. 1, with FIG. 1A being a top view, FIG. 1B a side view, and FIG. 1C being a perspective view of the present invention, the LED backlight module of the present invention comprises a light box 1 with four lateral walls and a base, defining a lower side; a heat conductor 2 on the base of the light box 1; an LED array 4, arranged in two linear rows and mounted on the heat conductor 2; a light mask 3, set above the LED array 4 at a suitable distance and diffused light generated; and an optical cover plate 5 on the light box 1, further diffusing light therefrom.

The light box 1 has inner walls coated or plated with material that reflects light directly or diffusely.

In the embodiment shown in FIG. 1, the heat conductor is placed on the base of the light box 1. In other embodiments, the heat conductor is made of several pieces, or the heat conductor is integrated into the base of the light box 1. The base of the light box 1 has an upper wall that is coated or plated with material that reflects light directly or diffusively.

By diffraction, reflection or total reflection, the light mask 3 causes lateral emission of light generated by the LED array 4, so that no light from the LED array 4 directly reaches the optical cover plate 5. Thus light generated by the LED array 4 is made diffuse in the light box 1 and further diffused by the optical cover plate 5, so that a uniform distribution of color and intensity thereof is achieved.

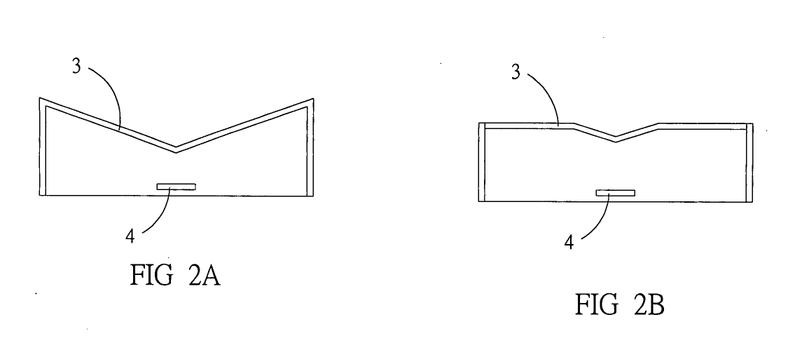

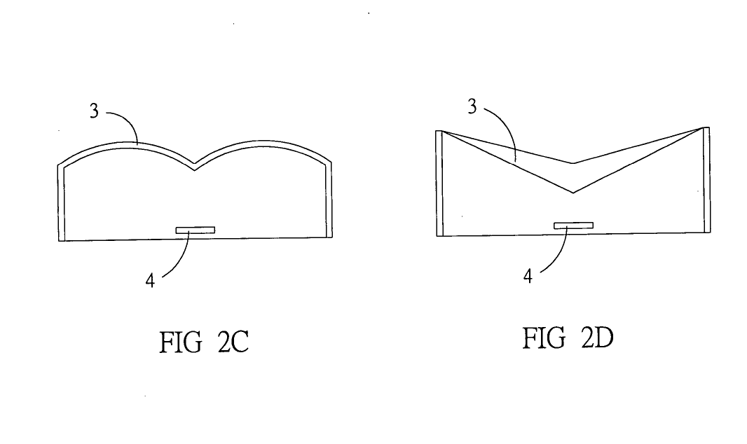

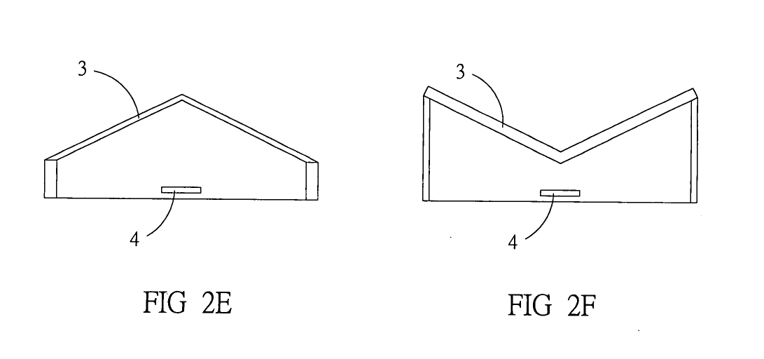

The light mask 3 made of PC, PMMA or PET achieves reflection by coating at inner or outer sides. As shown in FIGS. 2A-2F, various shapes of the light mask 3 are possible for achieving lateral emission of light by diffraction, reflection or total reflection, avoiding the direct exposure of the optical cover plate 5 to light generated by the LED array 4.

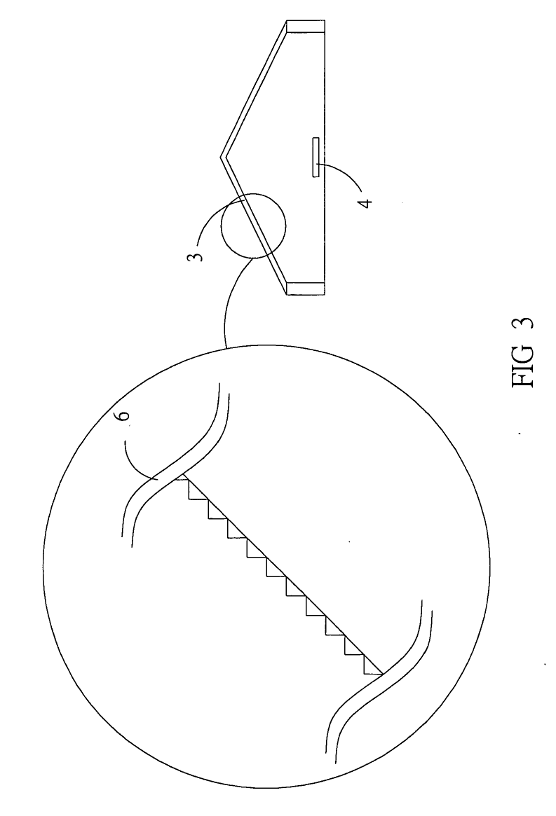

Furthermore, as shown in FIG. 3, the inner and outer sides alternatively have surface microstructures of prisms 6 or grating microstructure for reflecting light in various directions.

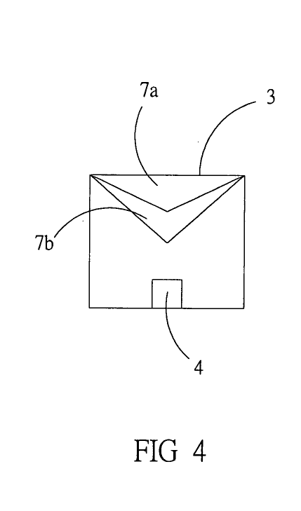

Referring to FIG. 4, in a further embodiment of the present invention, the light mask 3 has refractive surfaces 7a, 7b made of materials with different refractive indices, or particles are inserted to achieve a light-refractive effect.

The optical cover plate 5, by working, a microstructure or having partially reflective properties further reduces non-uniformity in color and intensity of emitted light.

1. An LED backlight module comprising:
a light box;
at least one heat conductor, placed in said light box;
a plurality of light emitting diodes (LEDs), mounted on said heat conductor;
a plurality of light masks, covering said plurality of light emitting diodes; and
a optical cover plate, set on said light box at upper side thereof, diffusing light that passes through.

2. The LED backlight module according to claim 1, wherein said light box has four lateral sides and a base, with said optical cover plate placed opposite to said base.

3. The LED backlight module according to claim 2, wherein said four lateral sides and said base of said light box have inner surfaces with either reflective or diffusely reflective properties.

4. The LED backlight module according to claim 2, wherein said heat conductor is mounted on said base of said light box.

5. The LED backlight module according to claim 2 wherein said heat conductor is integrated into said base of said light box.

6. The LED backlight module according to claim 1, wherein said plurality of LEDs is arranged in rows.

7. The LED backlight module according to claim 6, wherein said plurality of LEDs is mounted on said heat conductor as a chip-on-board structure.

8. The LED backlight module according to claim 1, wherein said light mask is made of transparent material.

9. The LED backlight module according to claim 8, wherein said light mask has inner and outer surfaces made of reflective material.

10. The LED backlight module according to claim 8, wherein said inner and outer surfaces of said light mask have surface relief of microprisms.

11. The LED backlight module according to claim 8, wherein said inner and outer surfaces of said light mask have diffractive surface relief.

12. The LED backlight module according to claim 8, wherein said light mask made of many kinds of the transparent materials with different refractive indices

13. The LED backlight module according to claim 8, wherein impurities are doped in said light mask to achieve the effect of variation of refraction index.

14. The LED backlight module according to claim 1, wherein said optical cover plate is made of conventional light dissipative material.

15. The LED backlight module according to claim 1, wherein said optical cover plate has surface relief of microstructure.

16. The LED backlight module according to claim 1, wherein said optical cover plate is made of partially reflective and partially transmissible material.
